(19) United States
(12) Patent Application Publication
(10) Pub. No.: US 2025/0197607 A1
(43) Pub. Date: Jun. 19, 2025

(54) A GRAPHENE OXIDE-THERMORESPONSIVE POLYMER COMPOSITE FILM

(71) Applicant: National University of Singapore, Singapore (SG)

(72) Inventors: Daria ANDREEVA-BAEUMLER, Singapore (SG); Konstantin NOVOSELOV, Singapore (SG); Kou YANG, Singapore (SG)

(21) Appl. No.: 18/867,372

(22) PCT Filed: May 20, 2023
(86) PCT No.: PCT/SG2023/050350

§ 371 Date: Nov. 19, 2024

(30) Foreign Application Priority Data
May 20, 2022 (SG) 10202205367T

(51) Int. Cl. C08L 1/28; C08J 7/06

(52) U.S. Cl. CPC C08L 1/284; C08J 7/06; C08J 2301/28

(57) ABSTRACT

A graphene oxide-thermoresponsive polymer composite film There is provided a two-dimensional (2D) graphene oxide-thermoresponsive polymer composite film comprising: at least two graphene oxide (GO) layers: and a thermoresponsive polymer layer between each GO layer, wherein the thermoresponsive polymer layer switches between being aligned and being disoriented between the at least two GO layers when temperature of the composite film changes from being below lower critical solution temperature (LCST) of the thermoresponsive polymer comprised in the composite film to being above the LCST of the thermoresponsive polymer. There is also provided a method of forming the composite film.

### TECHNICAL FIELD

The present invention relates to a composite film and a method of forming the same.

### BACKGROUND

Hydrogels have a huge potential to fulfil current and future requirements for new functional intelligent materials for bionics, smart membranes, programmable textile, soft robotics, wearable electronics, and smart housing. Classical hydrogels are 3D polymeric networks that undergo reversible swelling/shrinking in response to environmental changes. Applications of hydrogels are based on their capability to switch between hydrophobic and hydrophilic states depending on temperature, pH, ionic strength, (in hydrophilic state hydrogels uptake water, in hydrophobic state release water). Such mass-changing properties are used for actuating in soft robotics and smart drug delivery devices.

However, 3D hydrogels have been slow to respond, are mechanically weak, low in functionalities, and undergo a slow continuous macroscopic swelling. Thus, there is a need for an improved hydrogel.

### SUMMARY OF THE INVENTION

The present invention seeks to address these problems, and/or to provide an improved hydrogel in the form of a composite film, particularly a composite film comprising a two-dimensional (2D) material.

According to a first aspect, the present invention provides a two-dimensional (2D) graphene oxide-thermoresponsive polymer composite film comprising:
at least two graphene oxide (GO) layers; and
a thermoresponsive polymer layer between each GO layer,
   wherein the thermoresponsive polymer layer switches between being aligned and being disoriented between the at least two GO layers when temperature of the composite film changes from being below lower critical solution temperature (LCST) of the thermoresponsive polymer comprised in the composite film to being above the LCST of the thermoresponsive polymer.

According to a particular aspect, the composite film may comprise the at least two GO layers in a layer-by-layer assembly. In particular, the composite film may be formed by self-assembly of the at least two GO layers and the thermoresponsive polymer layer.

The thermoresponsive polymer comprised in the thermoresponsive polymer layer of the composite film may be any suitable thermoresponsive polymer. According to a particular aspect, the thermoresponsive polymer layer may comprise, but is not limited to, LCST polymers. In particular, the thermoresponsive polymer layer may comprise, but is not limited to, cellulose derivatives.

According to a particular aspect, the thermoresponsive polymer comprised in the thermoresponsive polymer layer may be hydrophobic when the thermoresponsive polymer layer is aligned between the at least two GO layers, and the thermoresponsive polymer comprised in the thermoresponsive polymer layer may be hydrophilic when the thermoresponsive polymer layer is disoriented between the at least two GO layers.

Each GO layer of the at least two GO layers and the thermoresponsive polymer layer may be bonded to one another via electrostatic interactions, hydrogen bonds, van der Waals interaction, hydrophobic interactions, or a combination thereof.

The composite film may be a free-standing composite film.

In particular, the composite film may have a suitable thickness. For example, the composite film may have an average thickness of 10 nm-100 μm.

According to a particular aspect, water flux through the composite film may be controlled by changes in orientation of thermoresponsive polymer layer between the at least two GO layers.

According to another particular aspect, the composite film may further comprise reduced GO (rGO).

According to a second aspect, there is provided a method of preparing the composite film according to the first aspect, the method comprising:
mixing a first solution comprising GO and a second solution comprising a thermoresponsive polymer to form a mixture; and
vacuum filtering the mixture onto a substrate surface to form the composite film.

The vacuum filtering may enable the formation of the composite film by self-assembly of GO layers and the thermoresponsive polymer layers.

According to a particular aspect, the method may further comprise drying the composite film following the vacuum filtering.

The method may further comprise reducing the GO layers to form reduced GO layers. In particular, the reducing the GO layers may comprise adding a reducing agent to at least a part of the composite film.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings. In the drawings:

FIG. 1 shows a schematic representation of the preparation of the composite film according to one embodiment;

FIG. 2 shows the chemical structure of graphene oxide (GO), the chemical structure of hydroxypropyl cellulose (HPC) and the FTIR spectra of GO, HPC and GO/HPC₂;

FIG. 3 shows the SEM image of the cross-section of free-standing GO/HPC₂ composite film;

FIG. 4 shows the XRD patterns of GO and GO/HPC₁ composite films;

FIG. 5 shows DLS size distribution of GO/HPC2 (0.01 mg mL⁻¹) at 25° C., DLS wavelength: 633 nm;

FIG. 6 shows DLS size distribution of GO/HPC2 (0.01 mg mL⁻¹) at 65° C., DLS wavelength: 633 nm;

FIG. 7 shows cyclic DLS size distribution of GO/HPC₂ (0.01 mg mL⁻¹) dispersion at 25° C. indicated by cycle number (from 1 to 10);

FIG. 8 shows cyclic DLS size distribution of GO/HPC₂ (0.01 mg mL⁻¹) dispersion at 65° C. indicated by cycle number (from 1 to 10);

FIG. 9 shows DLS peak position of GO/HPC₂ (0.01 mg mL⁻¹) dispersion at 25° C. and 65° C. Note that the peak near 1000 nm at 65° C. is not counted for better observation;

FIG. 10 shows a schematic representation of a set-up for measuring osmosis water permeation;

FIG. 11 shows HPC concentration-dependent water permeance of GO/HPC composite films at 25° C. (dark columns) and 65° C. (light columns) after a permeation duration of 8 hours;

FIG. 12 shows water permeance of GO/HPC₂ composite film (circles) and pristine GO (squares) membrane at different temperatures after permeation duration of 8 h; and

FIG. 13 shows cyclic water permeation test of GO/HPC₂ composite film. Permeation lasted for 8 h for each temperature and the test was performed on the same GO/HPC₂ membrane.

### DETAILED DESCRIPTION

As explained above, there is a need for an improved composite film.

In general terms, the present invention provides a composite film which is able to adjust itself to appropriate external conditions such as temperature. The composite film according to the present invention may be a layered composite film prepared by self-assembly of two-dimensional (2D) graphene oxide with thermoresponsive polymers. The heterogeneous amphiphilic surface of GO is compatible with the thermoresponsive polymers. Due to van der Waals interactions, GO forms nanochannels that create 2D nanostructured confinements for encapsulated molecules. By entrapment of thermoresponsive polymers in 2D layers, a controllable switching of typical hydrogels swelling/shirking cycles in 2D confinement may be achieved. Accordingly, the composite film may be used for fluid transport and function as a fluid valve to achieve directional transport of fluid, such as water.

According to a first aspect, the present invention provides a two-dimensional (2D) graphene oxide-thermoresponsive polymer composite film comprising:
at least two graphene oxide (GO) layers; and
a thermoresponsive polymer layer between each GO layer,
   wherein the thermoresponsive polymer layer switches between being aligned and being disoriented between the at least two GO layers when temperature of the composite film changes from being below lower critical solution temperature (LCST) of the thermoresponsive polymer comprised in the composite film to being above the LCST of the thermoresponsive polymer.

According to a particular aspect, the thermoresponsive polymer comprised in the thermoresponsive polymer layer may be hydrophobic when the thermoresponsive polymer layer is aligned between the at least two GO layers, and the thermoresponsive polymer comprised in the thermoresponsive polymer layer may be hydrophilic when the thermoresponsive polymer layer is disoriented between the at least two GO layers.

In this way, the changes of conformation and alignment of the thermoresponsive polymer molecules comprised in the composite film may be used as a switch for optical properties and liquid transport. In particular, the composite film may have a large swelling rate and is a highly stable layered structure which is able to respond to changes in temperature, making it capable of reversible swelling.

Each GO layer of the at least two GO layers and the thermoresponsive polymer layer may be bonded to one another by suitable non-covalent bonds. For example, each GO layer of the at least two GO layers and the thermoresponsive polymer layer may be bonded to one another via electrostatic interactions, hydrogen bonds, van der Waals interaction, hydrophobic interactions, or a combination thereof.

In particular, the electrostatic bond between each of the GO layer of the at least two GO layers and the thermoresponsive polymer layer may be by hydrogen bonding. The hydrogen bonding between the GO layer and the thermoresponsive polymer layer may result in the composite film being highly stable and robust, thereby having favourable mechanical properties such as high Young's modulus.

The at least two GO layers comprised in the composite film may be formed by any suitable method. According to a particular aspect, the composite film may comprise the at least two GO layers in a layer-by-layer assembly. In particular, the composite film may be formed by self-assembly of the at least two GO layers and the thermoresponsive polymer layer.

According to a particular aspect, each of the at least two GO layers may be an atomically thin layer.

According to another particular aspect, each of the at least two GO layers may comprise GO in any suitable form. For example, the GO comprised in the GO layer may comprise, but is not limited to, GO flakes, GO nanoparticles, GO quantum dots, or a combination thereof. In particular, the GO layer may comprise GO flakes. The GO flakes may have any suitable dimensions. For example, the GO flakes may have an average lateral size of 100-5000 nm and a thickness of 1-2 nm.

The thermoresponsive polymer comprised in the thermoresponsive polymer layer of the composite film may be any suitable thermoresponsive polymer. According to a particular aspect, the thermoresponsive polymer layer may comprise, but is not limited to, LCST polymers. In particular, the thermoresponsive polymer layer may comprise, but is not limited to, cellulose derivatives. For example, the thermoresponsive polymer may comprise, but is not limited to, hydroxypropyl cellulose (HPC), methyl cellulose, carboxymethyl cellulose, hydroxyethyl cellulose, or a combination thereof.

The composite film may have a suitable thickness. For example, the composite film may have an average thickness of 10 nm-100 μm. In particular, the composite film may have an average thickness of 50 nm-90 μm, 100 nm-75 μm, 300 nm-50 μm, 500 nm-25 μm, 750 nm-10 μm, 1-8 μm, 2-7 μm, 3-6 μm, 4-5 μm. Even more in particular, the average thickness may be >2 μm, 2-15 μm, 3-12 μm, 4-10 μm, 5-9 μm, 6-8 μm. According to a particular aspect, the composite film may be a free-standing composite film. The free-standing composite film may be a flexible free-standing composite film.

According to a particular aspect, water flux through the composite film may be controlled by changes in orientation of thermoresponsive polymer layer between the at least two GO layers.

According to another particular aspect, the composite film may further comprise reduced GO (rGO). In-situ reduction of GO to rGO may lead to the formation of conductive materials that can transfer electrical power into thermal energy via Joule heating. Accordingly, the composite film comprising GO/rGO layers with thermoresponsive polymers enable the composite film to have super electrical conductivity. For example, the electrical conductivity of the composite film may be 150-250 S/cm, 175-225 S/cm, 180-200 S/cm. Application of electrical energy to the composite film may generate joule heating to switch between aligned and disoriented configurations of the thermoresponsive polymers, thereby enabling transport of liquids. The composite film comprising rGO may therefore be comprised in an electro-thermo-responsive liquid valve.

In particular, the composite film may be incorporated in devices used for transferring fluids, such as water. GO layers, particular GO nanolayers comprised in the composite film, may provide a 2D liquid-like confinement to exploit temperature-controlled conformational changes of semi-flexible thermoresponsive polymer molecules. For example, at low temperatures, thermoresponsive polymer molecules may be hydrophilic coils and hydrogen-bonded to GO surface, whereas at high temperature, the thermoresponsive polymer molecules comprised in the composite film may be hydrophobic and collapse into a globular state. GO surface guides the alignment of hydrophilic thermoresponsive polymer molecules in 2D confinement and the formation of an optically active anisotropic phase of thermoresponsive polymer. The composite film therefore uptakes liquids, such as water, in its hydrophilic state and releases water in its hydrophobic state, therefore, functioning as 2D hydrogels.

Patterning of conductive reduced graphene oxide (rGO)/thermoresponsive polymer and GO/thermoresponsive hydrogels blocks allow coupling of electrical and/or thermal stimuli to certain actuations. The composite films may be utilised in fluid transport systems for, but not limited to, bionics, actuators for soft robotics, and bio-engineering solutions for smart houses.

According to a second aspect, there is provided a method of preparing the composite film according to the first aspect, the method comprising:
mixing a first solution comprising GO and a second solution comprising a thermoresponsive polymer to form a mixture; and
vacuum filtering the mixture onto a substrate surface to form the composite film.

The vacuum filtering may enable the formation of the composite film by self-assembly of GO layers and the thermoresponsive polymer layers.

According to another particular aspect, the first solution may comprise GO in any suitable form. For example, the GO comprised in the first solution may comprise GO flakes, GO nanoparticles, GO quantum dots, or a combination thereof.

The second solution may comprise any suitable thermoresponsive polymer. In particular, the thermoresponsive polymer may be as described above in relation to the first aspect. For example, the thermoresponsive polymer may be, but not limited to, hydroxypropyl cellulose (HPC), methyl cellulose, carboxymethyl cellulose, hydroxyethyl cellulose, or a combination thereof.

The mixing may comprise mixing a suitable amount of the GO with a suitable amount of the thermoresponsive polymer. In particular, the weight ratio of thermoresponsive polymer to GO may be 0.5-5, 1-4, 2-3.

According to a particular aspect, the mixture may comprise 13-60 wt % thermoresponsive polymer based on the total weight of the mixture. In particular, the mixture may comprise 15-58 wt %, 20-55 wt %, 24-53 wt %, 25-50 wt %, 30-45 wt %, 35-42 wt %, 37-40 wt % thermoresponsive polymer based on the total weight of the mixture. Even more in particular, the mixture may comprise 13.5-58.8 wt % thermoresponsive polymer based on the total weight of the mixture.

The mixing may be under suitable conditions. For example, the mixing may be at room temperature.

The mixing may be carried out for a pre-determined period of time. In particular, the mixing may be carried out in a shaker to ensure uniform mixing of the first solution and the second solution.

The vacuum filtering may be under suitable conditions. For example, the vacuum filtration may be carried out for a pre-determined period of time. The pre-determined period of time may be any suitable period of time. For example, the pre-determined period of time may be 1-6 hours, 2-5 hours, 3-4 hours. In particular, the pre-determined period of time may be about 3 hours.

The substrate onto which the membrane is deposited may be any suitable substrate. For example, the substrate may be a supporting filter.

According to a particular aspect, the method may further comprise drying the composite film following the vacuum filtering. The drying may be under suitable conditions. For example, the drying may be in a dry cabinet. In particular, the drying may be at a temperature of 20-40° C., 25-35° C., 27-30° C. The drying may be carried out for a pre-determined period of time.

The method may further comprise reducing the GO layers to form reduced GO layers. In particular, the reducing the GO layers may comprise adding a reducing agent to at least a part of the composite film.

As can be seen, the method is a low-cost method. Further, it may be easily scaled up to prepare the composite films on a larger scale.

Having now generally described the invention, the same will be more readily understood through reference to the following example which is provided by way of illustration, and is not intended to be limiting.

### EXAMPLE

### Materials

Aqueous graphene oxide dispersion (GO, 4 mg mL⁻¹, monolayer content >95%, Graphenea Inc., USA), Hydroxypropyl cellulose (HPC, Mw˜ 100,000, powder, 20 mesh particle size, Sigma-Aldrich), Polyethersulfon membrane filter (PES, 0.03 m, 47 mm, Sterlitech Corporation, USA), Anodisc 47™ filter (pore size—0.02 μm, diameter 47 mm, Whatman, USA), Hydriodic acid (HI, contains no stabilizer, ACS reagent, 55%, Sigma-Aldrich), Ethanol (absolute, ≥99.8%, Sigma-Aldrich), Silver conductive paint (RS Components, UK). All materials were received and used without further purification.

### Preparation of Composite Film

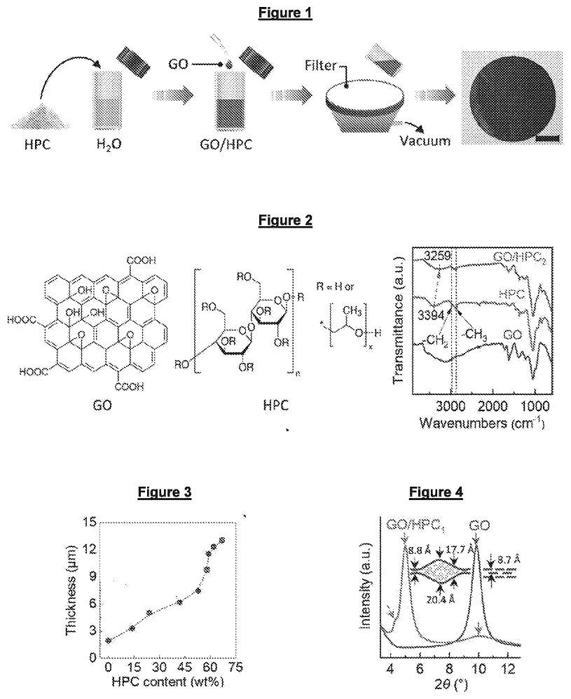

HPC/H₂O dispersion (1 mg mL⁻¹) was obtained by dissolving HPC (100 mg) in deionized water (DI water, 100 mL) upon sonication for 1 h. The original aqueous graphene oxide dispersion (4 mg mL⁻¹, 5 mL) was added into deionized water (195 mL) to obtain diluted GO dispersion (0.1 mg mL⁻¹). Then, HPC/H₂O (1 mL, 1 mg mL⁻¹) dispersion was mixed with GO dispersion (5 mL, 0.1 mg mL⁻¹), and the colloids were then mixed for 10 minutes by a shaker (rotation speed—500 rpm, Vortex Mixer, USA) to attach HPC molecules to GO surfaces. GO/HPC composite films were prepared by vacuum filtration of the aforesaid mixture through two types of membrane filters: Anodisc™ 47 and polyethersulfone membrane. Vacuum filtration was maintained for 3 hours, and the obtained composite film was then dried overnight in a dry cabinet at room temperature. A schematic representation of the preparation of the preparation of the composite film is as shown in FIG. 1.

The obtained composite nanoflakes are aligned by vacuum filtration to form self-assemblies of alternate GO and HPC nanolayers. Excess polymer molecules, that are not attached to the GO surface, are removed during the filtration process. Vacuum filtration leads to the gradual removal of dispersion medium (water with dissolved HPC molecules) and simultaneous self-assembly of dispersion phase (GO/HPC flakes) into self-assemblies.

The ratio of HPC to GO was controlled at 0.5, 1, 2, 3, 4 and 5 by introducing a different volume of HPC dispersion, and the resulting composite film were named GO/HPC_{0.5}, GO/HPC₁, GO/HPC₂, GO/HPC₃, GO/HPC₄, and GO/HPC₅ respectively. For comparison, a pristine GO film was prepared by vacuum filtrating 5 mL GO dispersion (0.1 mg mL⁻¹) through the filter.

### Characterization Methods

Thermogravimetric analysis (TGA) was performed by TA Instrument Discovery TGA1-0247 under nitrogen at a heating rate of 10° C./min. Differential scanning calorimetry (DSC) was conducted by Mettler Toledo DSC1 under nitrogen at a heating rate of 2° C./min. Attenuated total reflectance Fourier transform infrared (ATR-FTIR) spectra were obtained from the Bruker Alpha Platinum-ATR tool in the range of 400-4000 cm⁻¹ with 4 cm⁻¹ resolution. X-ray diffraction (XRD) was carried out on Bruker D8ADVANCE with a Cu Kα tube radiation source (1.5418 Å) in a step of 0.02° per second from 2° to 20°. Particle size was measured by a MALVERN ZSU5700 Zeta Sizer. The composite film thickness was measured by Alpha-Step IQ Surface Profiler (KLA Tencor). The mechanical properties was measured using Dynamic Mechanical Analyser (DMA 850, TA Instruments). Scanning electron microscopy (SEM) images were obtained by a ZEISS Sigma 300 FE SEM system. The composite film samples were sputtered with 5 nm gold before observation. Atomic Force Microscope (AFM) measurement was conducted by AFM Bruker EQB001 with a Bruker-TAC (thermal applications controller). Quartz-Crystal Microbalance (QCM) measurements were performed by the QSense Explorer System (QE 401 Electronic Unit, QCP 101 Chamber Platform, QFM 401 Flow Module). A 5 MHz Au electrode was used with the pump speed of 30 μL/min. Composite films for QCM measurements have the same composition ratio but only include 0.3 mg GO to achieve tight attachment on the Au electrode.

### Setup for Water Permeation Experiments

Water and permeation experiments were performed using a set of side-by-side diffusion cells (Yuyan Instruments, Shanghai) with a composite film fixed between two cell compartments, e.g. the feed compartment and the drain compartment. The feed compartment was filled with DI water (20 mL), while the drain compartment was sucrose (20 mL, 2.5 mol/L) to induce the osmotic pressure between two cell compartments. A water circulation system (Bilon Instruments, Shanghai) was used to control the external temperature of the diffusion cell. After 8 h of permeation, the weight of the sucrose solution was recorded to calculate the water flux.

### Fabrication of Electrically-Controlled GO/HPC Device

A free-standing GO/HPC₅ composite film was prepared via the method mentioned above. The GO/HPC₅ composite film was peeled off from the PES filter after drying and a quarter of the composite film was cut and used to fabricate the humidity device. To reduce only a part of the GO/HPC₅ membrane, 20 μL of HI was applied evenly on the middle part of the composite film. Note that the top and bottom parts of the membrane was remained unreduced to retain the thermo-responsive characteristic of GO/HPC. After 15 h, HI above the membrane was removed and the membrane was washed by ethanol for 5 times and rinsed by DI-water. To apply bias, two conductive copper wires were connected to the two ends of the reduced part by silver paint.

### Setup for Humidity Measurement

The above-mentioned partially reduce GO/HPC₅ composite film was fixed on a glass slide by conductive past and put into a 50 mL centrifuge tube. 4 mL of DI water was injected into the tube to create a humid environment without touching the glass slide. A hygrometer (RS-91, RS Components) was then inserted into the centrifuge tube and sealed for 30 minutes before measurement. A source meter (2401 SourceMeter®, Keithley) was used to apply bias on the composite membrane.

### Setup for Water Valve

A free-standing GO/HPC₅ composite film was prepared on a PES filter via the method mentioned above. A quarter of the GO/HPC₅ composite film (with PES filter on the bottom) was pasted above the 4 mL glass bottle with 4 mL DI-water inside by double-sided adhesive tape. The glass bottle with the composite film was then put on the weighing pan of an analytical balance (SECURA324-1S, Sartorius Lab Instruments). To fabricate a heating device, a free-standing 5 mg GO film was reduced by soaking in HI for 15 h and washed with ethanol and DI water. Two conductive copper wires were connected to the two ends of the rGO film. The rGO film was fixed on a glass slide, which was then hung above the GO/HPC₅ composite film with a distance of 5 mm. Bias was applied to the rGO film to heat the GO/HPC₅ composite film below it.

### Results

The composite films obtained are assembled at room temperature (RT=25° C.). According to the phase diagram at RT, HPC is hydrophilic and, thus, attracted to the hydrophilic GO surface due to predominant interactions of the hydrophilic functional groups of both compounds. As shown in Fourier-transform infrared (FT-IR) spectra (FIG. 2), the characteristic methyl and methylene peaks of HPC are observed in the spectrum of GO/HPC at 2869 and 2971 cm⁻¹, respectively. In addition, a red shift of —OH group (from 3394 cm⁻¹ for HPC to 3259 cm⁻¹ for GO/HPC) indicates hydrogen bonding between HPC molecules and hydrophilic functional groups of GO. Thus, the composites are stabilized by the formation of hydrogen bonds between oxygen-containing functional groups of glucose units (CH₂CH(OH)CH₃) and oxygen-containing functional groups of GO (—OH, —COOH).

The ratio of HPC to GO in the composite films was controlled by the concentration of HPC in the dispersions. Thermogravimetric analysis (TGA) analysis was used to calculate the amount of HPC in the composite films. The composite films with 13.5 wt %, 23.7 wt %, 42 wt %, 52.5 wt %, 58.3 wt %, and 58.8 wt % HPC were prepared. According to the composition, the composite films were assigned as (GO/HPC)_{0.5}, (GO/HPC)₁, (GO/HPC)₂, (GO/HPC)₃, (GO/HPC)₄, (GO/HPC)₅, respectively.

The self-assembly approach is a fast and easy method to fabricate large-scale free-standing GO/HPC composite film with excellent integrity and processability. The composite film has a typical GO paper lamellar morphology. For the evaluation of the thickness of membranes, a surface profiler. The thickness of GO/HPC composite films is gradually increased when the concentration of HPC in the composite films were increased, as seen in FIG. 3. The pure GO membrane was about 2 μm thick. The entrapment of 42 wt % of HPC led to the formation of ≈6 μm thick composite film. The GO/HPC composite film with the 58.8 wt % content of HPC was 12 μm thick.

GO nanosheets and HPC macromolecules were perfectly aligned to form a layered structure, as can be seen in FIG. 4. For further experiments, composite films with the concentration of HPC between 13.5 and 58.8 wt % were used.

In order to investigate the mechanical properties, Young's modulus and ultimate tensile strength for GO membranes and the composite films were compared. The ultimate tensile strength of GO membranes decreased when HPC molecules were entrapped in 2D confinement of GO. Thus, the change in the ultimate tensile strength for GO/HPC composite film was due to the formation of cross-linking between GO nanolayers and HPC via hydrogen bonding. The Young's modulus was 2.5 GPa for both GO membranes and 2D GO/HPC hydrogels. This value was several orders larger than those measured for the traditional hydrogels (450-490 kPa). It was also observed that the GO/HPC composite films with minimum (13.5 wt %) and maximum (58.8 wt %) HPC content had similar mechanical properties. Thus, the entrapment of 13.5 wt % of HPC has a major contribution to the formation of stable hydrogen-bonded composite materials. The change in mechanical properties of GO upon entrapment of HPC is due to the cross-linking via hydrogen bonding. Overall, cross-linking is a major factor to ensure the stability of 2D GO/HPC hydrogel.

X-ray diffraction (XRD) patterns, dynamic light scattering (DLS) particle analysis, and atomic force microscopy (AFM) were used to confirm the attachment, distribution, and conformational changes of HPC molecules on GO surface. As seen in FIG. 4, the interlayer distance of pure GO membrane is 8.7 Å. According to XRD patterns, the encapsulation of 23.7 wt % of HPC led to the formation of layered materials with the interlayer distance of 8.7, 17.7, and 20.4 Å. XRD patterns showed that when HPC content (>23.7% of HPC) increased, interlayer distance between GO layers gradually increased.

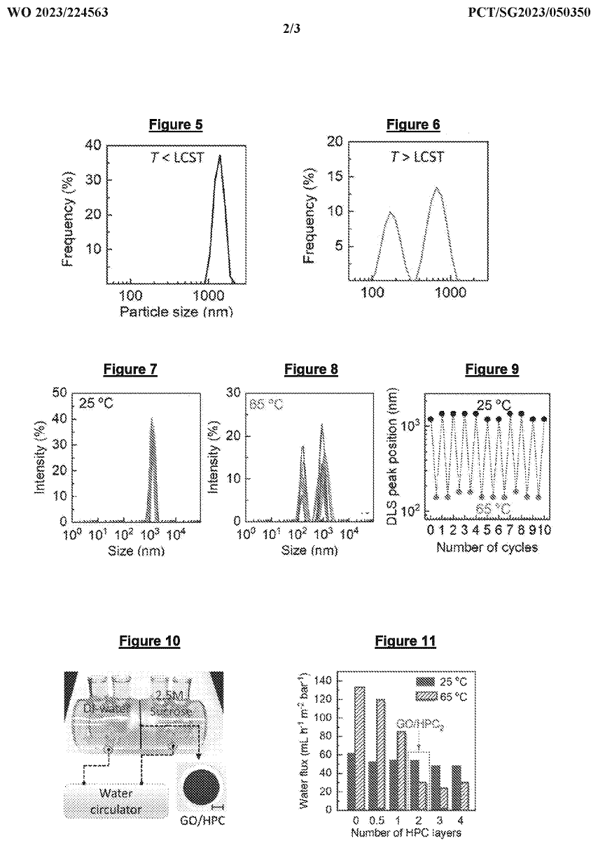

At RT DLS particle analysis, FIG. 5 shows the presence of ≈1 μm large particles that can be attributed to GO flakes with attached HPC molecules. AFM images showed that the expanded HPC coils formed a homogeneously distributed polymer network on the GO surface, especially obvious in samples with higher HPC concentration. Furthermore, polarization image of the GO surface decorated by HPC revealed that HPC was highly ordered at the GO surface and exhibited typical liquid crystal (LC) phase birefringence characteristic behaviour in polarized light.

At 65° C., DLS particle analysis done on the composite film detected the presence of two types of particles with approximate sizes of 100 nm and 1 μm (FIG. 6). 1 μm particles corresponded to GO flakes and 100 nm particles were hydrophobic aggregates of collapsed HPC coils in water. Indeed, according to the phase diagram above LCST, HPC molecules aggregate in water due to the interaction between hydrophobic groups that are dominant at high T. At 65° C. the polymer network collapsed in polymer aggregates. The height of the collapsed coils was ≈3 nm and the length and the width of aggregates were ≈100-200 nm. The polarization image of the GO surface decorated by HPC obtained at 65° C. revealed birefringent behaviour in polarized light.

It was shown that hydrophilic interactions drive the attachment of HPC molecules to the GO surface. In contrast, hydrophobic interactions drive the self-organization between HPC molecules. At higher concentrations of HPC on GO surface, the presence of even 5-7 μm large aggregates was detected due to self-organization of GO/HPC driven by highly concentrated hydrophobic HPC fraction. Birefringent of the composite films at low T may be explained by the formation of ordered anisotropic materials stabilized by hydrophilic interactions of GO and HPC. At high T, hydrophobic intramolecular interactions in HPC fraction are dominant. HPC molecules are partially reoriented in less ordered hydrophobic domains. The residual polarization can be explained by the anisotropy of a monolayer HPC attached to the GO surface. The T-induced hydrophilic/hydrophobic transitions were reproducible as revealed by cyclic DLS measurement (FIG. 7-9). Note that DLS size distributions versus T for pure GO flakes revealed the presence of ≈1 μm particles in the whole T range. DLS size distributions versus T for pure HPC showed one fraction at 7-20 nm at T<LCST and the other fraction at 100-300 nm at T>LCST. According to DLS, free HPC exhibits LCST around 43° C. GO/HPC also exhibited LCST around 43° C. Thus, the GO surface effectively aligned HPC molecules and guided their redistribution for many cycles. Importantly, it was possible to reversibly switch between collapsed and expanded states of HPC coils on GO surface in the presence of water. The fully reversible switch between expanded coil and collapsed helix conformations of HPC was observed upon heating/cooling cycles on the GO surface. Birefringent properties of the composite films also depended on the concentration of encapsulated HPC.

Pure GO layers did not show any rotation of the polarization plane. GO composite films with a low concentration of HPC demonstrated the LC state in the whole temperature range from RT to 75° C. Using the number of mols of 100 kDa HPC molecules and their calculated gyration radius (R_{g}), the number of HPC layers that might be encapsulated between each GO nanosheet was estimated. It was calculated that a monomolecular layer of HPC may be formed when 23.7% of HPC was entrapped. Indeed, when HPC content was <23.7% the presence of pure GO layers with an interlayer distance of 8.7 Å was observed in XRD patterns (FIG. 4). A monolayer of HPC may form permanently aligned domains hydrogen-bonded to the GO surface which remained anisotropic at all temperatures.

When the concentration of HPC was increased, an obvious colour change was observed with increasing T. T-induced phase transitions was seen around 70° C. for the samples with 42 wt % of HPC and around 50° C. for 58.8 wt % of HPC, respectively. Such transitions may be due to the presence of the mobile HPC phase between GO layers. Indeed, XRD patterns of the composite films with the >23.7 wt % of HPC content did not show the peak that corresponded to the interlayer distance in pure GO layers. The encapsulation of >23.7 wt % of HPC in GO layers further increased the interlayer distance to 20.8 Å.

Polarization images together with DLS, AFM, and XRD data showed that GO surface induces orientation of HPC due to the hydrophilic interactions between GO and HPC. At low concentration of HPC, a monolayer of HPC was hydrogen-bonded to GO surface to form a stable composite. A switch in optical properties was not observed up to 75° C. At a higher concentration of HPC, the transition T decreased due to the presence of a mobile bulk HPC phase. At RT, GO surface induced orientation of HPC due to hydrophilic interactions between GO and HPC. At high T, HPC molecules were reoriented in 2D confinement of GO and less ordered domains were formed due to hydrophobic interactions. Thermo-responsive reorientation and alignment of HPC molecules were also associated with the uptake and release of water molecules. Inherently, GO nanolayers and water molecules may create a unique 2D liquid-like environment for encapsulated hydrophilic HPC molecules. Upon heating/cooling GO may guide reversible reorientation and alignment of HPC in the composite films. However, when HPC turned to a hydrophobic state, the change in orientation of the hydrophobic domains produced stresses and strains which trigger the transport of water molecules.

To monitor water uptake/release by the 2D hydrogels, water permeability tests were conducted and swelling/shrinking of the composite films was monitored, depending on composition and temperature. First, water flux through the composite films was measured in a dual-cell set-up using osmotic pressure as a driving force, as shown in FIG. 10. As seen in FIG. 11, pure GO membranes were more permeable at higher T and less permeable at RT. However, the encapsulation of 2 layers of HPC allowed achieving the LCST behaviour of composite film. GO/HPC with 2-5 layers of HPC were more permeable at RT in hydrophilic state of HPC and less permeable at high T in hydrophobic state of HPC.

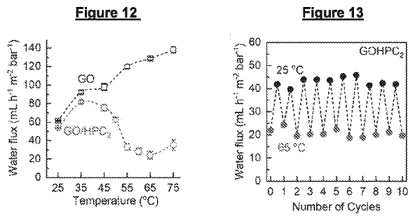

FIG. 12 shows the permeability profiles versus T for GO membrane and GO/HPC₂ composite film. GO membranes demonstrated a monotonic water flux dependence on temperature: lower permeability at RT and higher permeability at higher T. However, GO/HPC₂ composite films had strongly non-monotonic permeability change versus T. The maximum permeability near LCST and lower permeability at T<LCST and T>LCST was measured. The maximum permeability around LCST might be explained by the low free energy of mixing between all components—GO, HPC, and water. Thus, in this state, the materials may be very sensitive to even tiny environmental perturbations.

Cyclic permeation experiments (FIG. 13) revealed that the GO/HPC composite film may keep perfect integrity and maintain switchable hydrophilic/hydrophobic properties after 10 cycles (the maximum that was measured). In the permeation measurements, external pressure (2.5 M sucrose solution) was applied to drive the water flux. A reversible switch of water flux from 40 mL h⁻¹ m⁻² bar⁻¹ (25° C.) to 20 mL h⁻¹ m⁻² bar⁻¹ (65° C.) was observed for GO/HPC₂ membrane. At such conditions, the water permeability of pristine GO membranes is ≈3 times higher than the water permeability of the composite films. In pure GO membranes, the faster water flux might be provided by hydrophilic nanochannels between GO nanosheets. In the composite films, the nanochannels are filled by HPC molecules that slow down water transport.

Temperature control over the interlayer spacing allows management of water uptake by GO/HPC composite films and GO membrane, which can be measured by the change in vibration frequency of quartz crystal microbalances'(QCM) chips. Mass uptake by the composite film is proportional to a decrease in the vibration frequency. The GO membrane showed a very small amplitude of water uptake/release when the temperature rises from 25 to 65° C. In contrast, GO/HPC composite films have a high amplitude of T-induced modulation of water uptake. Under room temperature, the prepared composite hydrogel had a swelling rate parameter of 135 s and a water content up to 95 wt % for 9 min. Furthermore, upon heating/cooling cycles GO/HPC nanolayer uptook/released a large amount of water within 1 h. In 3D hydrogels, swelling/shrinking equilibrium time is proportional to dimensions of 3D networks and can take from several hours to days. In the present case, the 2D composite films consumed and released the amount of water that is ≈10 times larger than the weight of the composite film itself. 1 mg GO/HPC composite uptook/released 10±2 mg of water. Note that the thermoresponsive swelling of GO/HPC composite films was also reversible as revealed by cyclic QCM measurements. Thus, 2D GO/HPC hydrogel may serves as a water valve.

The formation of patterned 2D hydrogels with GO and conductive rGO blocks opens the possibility to use Joule heating to change the temperature and thus the water adsorption properties of the composite films. Considering the low specific heat of rGO—such devices can be very fast. A 2D valve device was assembled based on coupled electrical-thermoresponsive working principle. Electrical power was applied to manipulate the device's temperature via Joule heating and to switch hydrophobicity and optical properties on demand. To make the composite films responsive to electrical stimulus, the GO nanosheets were partially reduced by hydriodic (HI) acid to form a patterned surface of conductive rGO/HPC₅ and GO/HPC₅ hydrogels. To create a patterned surface, a particular part of the GO/HPC₅ composite film was selectively reduced by 20 μL of HI. A decreased interlayer distance of the composite film (3.6 Å) and an increased D/G intensity ratio (I_{D}/I_{G} =1.34) was observed after reduction, suggesting a decrease in the average size of the sp² domains. After reduction, the composite film consisted of the electrically sensitive conductive rGO/HPC⁵ blocks and the thermo-sensitive 2D hydrogel with high water uptake capacitance. Thus, the prepared 2D composite film material combines vertical heterostructure and lateral heterostructure. The conductivity of the device was 176 S cm¹, which is greater by several orders than traditional hydrogels (5 ×10⁻³ S cm⁻¹).

To test the response of the device to Joule heating, a freestanding composite film was integrated into a humidity chamber. To apply an electrical stimulus, two copper wires were connected to the two corners of the reduced part by silver paint. The humidity test showed that the water uptake/release from the GO/HPC₅ membrane may be easily manipulated by applying electrical power. The electrical stimulus applied to the conductive rGO/HPC₅ blocks mediated local heating to hydrophilic GO/HPC₅ blocks and turn them hydrophobic. When electrical power was “OFF”, the composite films uptook water from the humid atmosphere. When power was “ON”, the composite films released water. The uptake/release cycles were reproducible. Furthermore, the composite membranes showed a high amplitude of response. The relative humidity changes between 96% and 86% in “ON” and “OFF” cycles corresponded to the cyclic transport of 0.6 mg of water. In contrast, the GO membranes had a small amplitude of response and water uptake/release was achieved for one cycle only.

It was also investigated to see if the 2D hydrogels could transfer water from one environment to another one and function as 2D low footprint water valves. To fabricate a water valve device, GO/HPC₅ composite film (with a porous filter on the bottom) was assembled above the glass bottle filled with 4 mL DI-water. Analytical balance was used to monitor the amount of transferred water. To fabricate an electrically controlled device, a free-standing GO membrane was reduced to rGO by soaking in HI for 15 h and washed with ethanol and DI water. Two copper wires were attached to the two ends of the rGO membrane. The rGO membrane was fixed on a glass slide, which was then hung above the GO/HPC₅ composite film at a distance of 5 mm. Electrical power was applied to the rGO membrane, which generated enough heat to reversibly switch hydrophilic/hydrophobic properties of the underneath 2D GO/HPC₅ hydrogel composite film. Driven by Joule heat generated by electricity, 2D GO/HPC₅ hydrogel composite film could serve as a water valve to transfer water directionally. By switching the power “OFF”, hydrophilic GO/HPC composite film uptakes water. When the power is “ON”, the composite films release water via evaporation from hydrophobic interior of the composite film. ON/OFF cycles guarantee continuous water transportation with a rate of 5 mg min⁻¹ when 0.3 A current is applied. Additionally, the operation of the 2D water valves may be monitored by changing the optical properties of the composite films.

Whilst the foregoing description has described exemplary embodiments, it will be understood by those skilled in the technology concerned that many variations may be made without departing from the present invention.

1. A two-dimensional (2D) graphene oxide-thermoresponsive polymer composite film comprising:
at least two graphene oxide (GO) layers; and
a thermoresponsive polymer layer between each GO layer,
wherein the thermoresponsive polymer layer switches between being aligned and being disoriented between the at least two GO layers when temperature of the composite film changes from being below lower critical solution temperature (LCST) of the thermoresponsive polymer comprised in the composite film to being above the LCST of the thermoresponsive polymer.

2. The composite film according to claim 1, wherein the thermoresponsive polymer comprised in the thermoresponsive polymer layer is hydrophobic when the thermoresponsive polymer layer is aligned between the at least two GO layers and wherein the thermoresponsive polymer comprised in the thermoresponsive polymer layer is hydrophilic when the thermoresponsive polymer layer is disoriented between the at least two GO layers.

3. The composite film according to claim 1, wherein the composite film is formed by self-assembly of the at least two GO layers and the thermoresponsive polymer layer.

4. The composite film according to claim 1, wherein each GO layer of the at least two GO layers and the thermoresponsive polymer layer are bonded to one another via electrostatic interactions, hydrogen bonds, van der Waals interaction, hydrophobic interactions, or a combination thereof.

5. The composite film according to claim 1, wherein the composite film comprises the at least two GO layers in a layer-by-layer assembly.

6. The composite film according to claim 1, wherein the thermoresponsive polymer layer comprises LCST polymers.

7. The composite film according to claim 6, wherein the thermoresponsive polymer layer comprises cellulose derivatives.

8. The composite film according to claim 1, wherein the composite film has an average thickness of 10 nm-100 μm.

9. The composite film according to claim 8, wherein the composite film has an average thickness of 2-100 μm.

10. The composite film according to claim 1, wherein the composite film is a free-standing composite film.

11. The composite film according to claim 1, wherein water flux through the composite film is controlled by changes in orientation of thermoresponsive polymer layer between the at least two GO layers.

12. The composite film according to claim 1, wherein the composite film further comprises reduced GO (rGO).

13. A method of preparing the composite film according to claim 1, the method comprising:
mixing a first solution comprising GO and a second solution comprising a thermoresponsive polymer to form a mixture; and
vacuum filtering the mixture onto a substrate to form the composite film.

14. The method according to claim 13, wherein the vacuum filtering enables the formation of the composite film by self-assembly of GO layers and thermoresponsive polymer layers.

15. The method according to claim 13, wherein the method further comprises drying the composite film following the vacuum filtering.

16. The method according to claim 13, wherein the method further comprises reducing the GO layers to form reduced GO layers.

17. The method according to claim 16, wherein the reducing the GO layers comprises adding a reducing agent to at least a part of the composite film.
